(19) United States
(12) Patent Application Publication
(10) Pub. No.: US 2023/0004680 A1
(43) Pub. Date: Jan. 5, 2023

(54) APPARATUS AND METHOD FOR VERIFYING INTEGRITY OF HARDWARE BOARD

(71) Applicant: ELECTRONICS AND TELECOMMUNICATIONS RESEARCH INSTITUTE, Daejeon (KR)

(72) Inventors: Yong-Je CHOI, Daejeon (KR); Dae-Won KIM, Daejeon (KR); Sang-Su LEE, Daejeon (KR); Byeong-Cheol CHOI, Daejeon (KR); Dong-Wook KANG, Daejeon (KR); Ik-Kyun KIM, Daejeon (KR); Yang-Seo CHOI, Daejeon (KR)

(73) Assignee: ELECTRONICS AND TELECOMMUNICATIONS RESEARCH INSTITUTE, Daejeon (KR)

(21) Appl. No.: 17/738,524

(22) Filed: May 6, 2022

(30) Foreign Application Priority Data
Jun. 30, 2021 (KR) 10-2021-0086012

(51) Int. Cl. G06F 21/70; G06F 21/57

(52) U.S. Cl. CPC G06F 21/70; G06F 21/572; G06F 2221/033

(57) ABSTRACT

Disclosed herein are an apparatus and method for verifying the integrity of a hardware board. The apparatus includes one or more processors and execution memory for storing at least one program that is executed by the processors, wherein the program is configured to compare images of components arranged on a verification target board and a source board in a first image, obtained by photographing the verification target board, and in a second image prestored for the source board, as to whether images of the components are identical to each other, and compare first firmware extracted from the verification target board with second firmware of the source board, as to whether first firmware is identical to second firmware and verify integrity of the verification target board based on whether the images are identical to each other and on whether the pieces of firmware are identical to each other.

### CROSS REFERENCE TO RELATED APPLICATION

This application claims the benefit of Korean Patent Application No. 10-2021-0086012, filed Jun. 30, 2021, which is hereby incorporated by reference in its entirety into this application.

### BACKGROUND OF THE INVENTION

### 1. Technical Field

The present invention relates generally to hardware security technology, and more particularly to technology for verifying board integrity.

### 2. Description of the Related Art

The development of Information Technology (IT) attributable to the information-oriented age causes changes not only in the daily lives of users, but also in industrial ecosystems. As a result, most manufacturers have configured and utilized various types of hardware or software throughout an entire process from the design of products to production, sales, and maintenance of products. The term “supply chain” means a set of individual enterprises that supply all parts and services required for production, distribution and maintenance of products for sale.

Here, hardware and software that are used are supplied to enterprises through a manufacturing and distribution process. During such a supply process, the hardware and software may be exposed to various types of security threats such as hacking, and thus the urgent need to ensure the security of a supply chain has recently arisen. In particular, because it is very difficult to analyze and detect backdoor attacks based on hardware, the incidence of backdoor attacks has gradually increased, and various real-world security incidents related to such backdoor attacks have been reported.

Meanwhile, Korean Patent Application Publication No. 10-2007-0040896 entitled “Method of system authentication and security enforcement using self-integrity checking based on tamper-proof H/W” discloses a method for generating a security-strengthening module which guarantees a secure computing environment and for strengthening the security of the security-strengthening module using tamper-proof hardware (H/W) by securing the integrity of a security program or the like installed to strengthen the security of a booting process and the system.

### SUMMARY OF THE INVENTION

Accordingly, the present invention has been made keeping in mind the above problems occurring in the prior art, and an object of the present invention is to verify the integrity of a hardware board of a supply chain.

Another object of the present invention is to detect malicious modification when a board is modified with malicious intent.

A further object of the present invention is to verify integrity in a board environment in which it is difficult to extract firmware.

In accordance with an aspect of the present invention to accomplish the above objects, there is provided an apparatus for verifying integrity of a hardware board, including one or more processors, and execution memory for storing at least one program that is executed by the one or more processors, wherein the at least one program is configured to compare images of components arranged on a verification target board and a source board with each other in a first image, obtained by photographing the verification target board, and in a second image prestored for the source board, as to whether the images of the components are identical to each other, and compare first firmware extracted from the verification target board with second firmware of the source board, as to whether the first firmware is identical to the second firmware and verify the integrity of the verification target board based on whether the images are identical to each other and on whether the pieces of firmware are identical to each other.

The at least one program may be configured to normalize the first image and the second image into an identical shape with respect to board sizes and board directions of the first and second images.

The at least one program may be configured to compare pieces of data that are extracted through a hash operation and an unpack operation by the first firmware and the second firmware.

The unpack operation may be configured to separate a bootloader, a kernel, and an operating system, as respective pieces of data, from corresponding firmware and to decompress compressed data.

The at least one program may be configured to extract the first firmware using a micro-probe when the verification target board is in a state in which a memory interface is unavailable and a memory pin is exposed outside.

The at least one program may be configured to extract the first firmware by causing a memory reader to directly access a memory chip removed from the verification target board when the verification target board is in a state in which a memory interface is unavailable in and a memory pin is not exposed outside.

In accordance with another aspect of the present invention to accomplish the above objects, there is provided a method for verifying integrity of a hardware board, the method being performed by an apparatus for verifying the integrity of the hardware board, the method including comparing images of components arranged on a verification target board and a source board with each other in a first image, obtained by photographing the verification target board, and in a second image prestored for the source board, as to whether the images of the components are identical to each other; comparing first firmware extracted from the verification target board with second firmware of the source board, as to whether the first firmware is identical to the second firmware; and verifying the integrity of the verification target board based on whether the images are identical to each other and on whether the pieces of firmware are identical to each other.

Comparing the images of the components may include normalizing the first image and the second image into an identical shape with respect to board sizes and board directions of the first and second images.

Comparing the first firmware extracted from the verification target board with the second firmware of the source board may include comparing pieces of data that are extracted through a hash operation and an unpack operation by the first firmware and the second firmware.

The unpack operation may be configured to separate a bootloader, a kernel, and an operating system, as respective pieces of data, from corresponding firmware and to decompress compressed data.

Comparing the first firmware extracted from the verification target board with the second firmware of the source board may further include extracting the first firmware using a micro-probe when the verification target board is in a state in which a memory interface is unavailable and a memory pin is exposed outside.

Comparing the first firmware extracted from the verification target board with the second firmware of the source board may further include extracting the first firmware by causing a memory reader to directly access a memory chip removed from the verification target board when the verification target board is in a state in which a memory interface is unavailable in and a memory pin is not exposed outside.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an operation flowchart illustrating a method for verifying the integrity of a hardware board according to an embodiment of the present invention;

FIG. 2 is an operation flowchart illustrating in detail an example of the board hardware image checking step illustrated in FIG. 1;

FIGS. 3 and 4 are diagrams illustrating a board image normalization process according to an embodiment of the present invention;

FIG. 5 is a diagram illustrating component images for which image-checking results for hardware boards are determined to be inconsistent according to an embodiment of the present invention;

FIG. 6 is an operation flowchart illustrating in detail an example of the board firmware checking step illustrated in FIG. 1;

FIG. 7 is an operation flowchart illustrating in detail an example of the step of extracting firmware from a verification target board, illustrated in FIG. 6;

FIG. 8 is a diagram illustrating a process of extracting firmware from a verification target board according to an embodiment of the present invention; and

FIG. 9 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present invention will be described in detail with reference to the attached drawings.

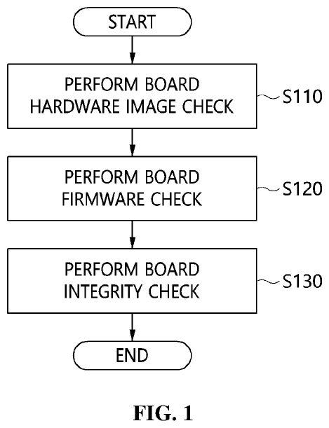

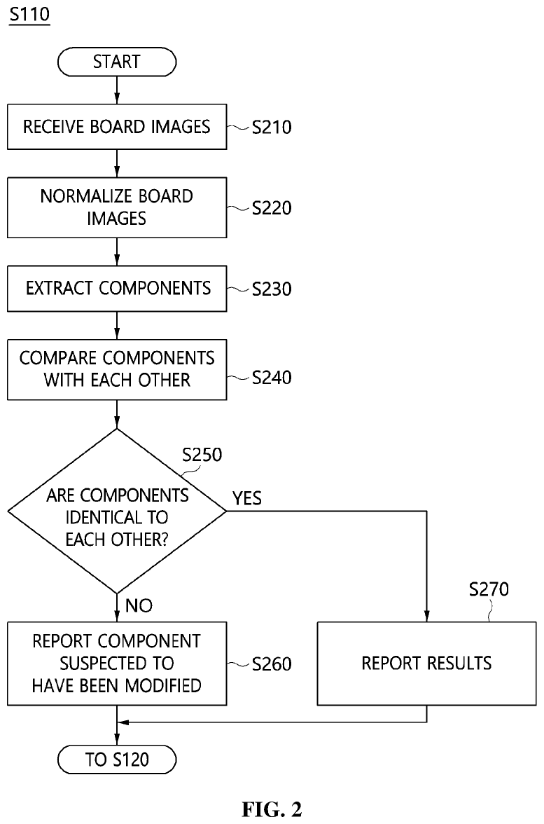

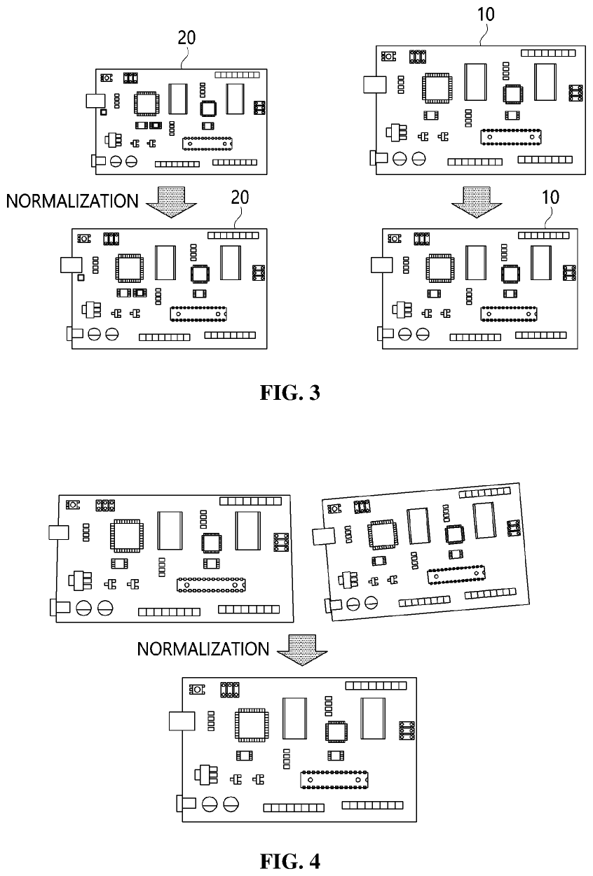

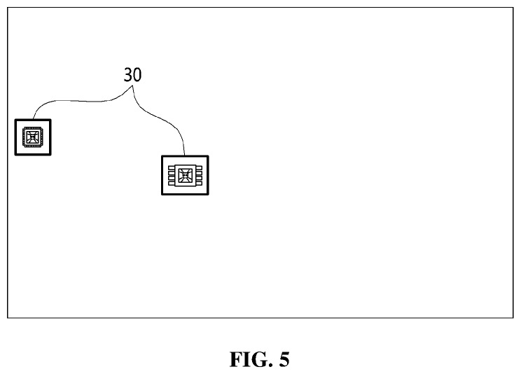

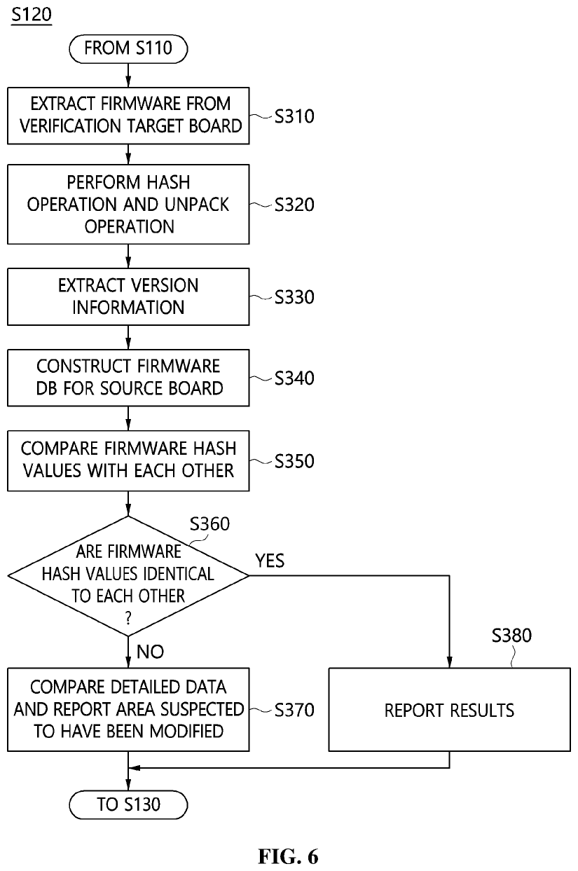

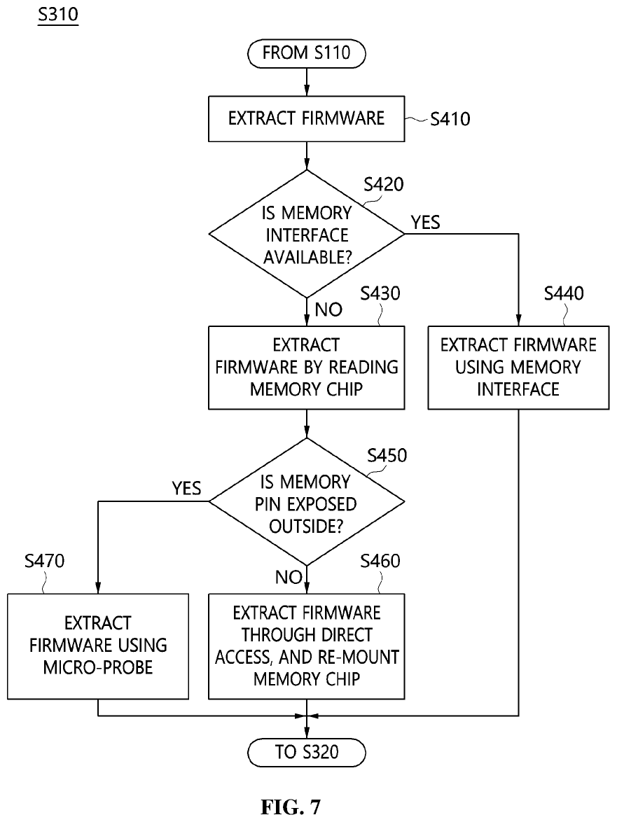

FIG. 1 is an operation flowchart illustrating a method for verifying the integrity of a hardware board according to an embodiment of the present invention. FIG. 2 is an operation flowchart illustrating in detail an example of the board hardware image checking step illustrated in FIG. 1. FIGS. 3 and 4 are diagrams illustrating a board image normalization process according to an embodiment of the present invention. FIG. 5 is a diagram illustrating a component image for which image-checking results for a hardware board are determined to be inconsistent according to an embodiment of the present invention. FIG. 6 is an operation flowchart illustrating in detail an example of the board firmware checking step illustrated in FIG. 1. FIG. 7 is an operation flowchart illustrating in detail an example of the step of extracting firmware from a verification target board, illustrated in FIG. 6.

Referring to FIG. 1, the method for verifying the integrity of a hardware board according to the embodiment of the present invention may perform a board hardware image check at step S110.

That is, at step S110, in a first image obtained by photographing a verification target board and in a second image prestored for a source board, images of components arranged on the boards are compared with each other, as to whether the images of the components are identical to each other.

Referring to FIG. 2, in a procedure at step S110, the board images may be received at step S210.

That is, at step S210, the first image obtained by photographing the verification target board and the second image prestored for the source board may be received.

Also, in the procedure at step S110, the board images may be normalized at step S220.

In detail, at step S220, the first image and the second image may be normalized into shapes having the same board size and the same board direction.

Referring to FIG. 3, at step S220, a normalization process of checking board areas of the first image and the second image and making the first image and the second image into rectangular images having the same size is illustrated.

Here, it can be seen that the images of a source board 10 and a verification target board 20 are normalized to be arranged in the same direction through the normalization process.

Referring to FIG. 4, when the verification target board 20 is rotated or shifted in a specific direction, the verification target board 20 may be normalized such that it is arranged in the same direction as the source board 10 through the normalization process.

Also, in the procedure at step S110, components may be extracted at step S230.

That is, at step S230, the components on the verification target board and the components on the source board may be extracted from the normalized first and second images, respectively.

Further, in the procedure at step S110, the components may be compared with each other at step S240.

That is, at step S240, in the normalized first image and the normalized second image, the components on the verification target board may be compared with the components on the source board, as to whether the components are identical to each other.

Also, in the procedure at step S110, whether the components are identical to each other may be determined at step S250.

That is, at step S250, when an extracted component on the verification target board is not identical to the corresponding component on the source board, it may be determined that the corresponding component is a component suspected to have been modified, and the results of the determination may be reported at step S260. On the other hand, when the extracted components are identical to each other, the results of the determination may be reported at step S270.

Referring to FIG. 5, component images 30 for which image-checking results for hardware boards are determined to be inconsistent are shown.

Next, the method for verifying the integrity of a hardware board according to the embodiment of the present invention may perform a board firmware check at step S120.

That is, at step S120, first firmware extracted from the verification target board may be compared with second firmware of the source board, as to whether the first firmware is identical to the second firmware.

Referring to FIG. 6, in a procedure at step S120, firmware may be extracted from the verification target board at step S310.

Referring to FIG. 7, in a procedure at step S310, firmware may be extracted at step S410.

Here, at step S410, the firmware of the source board may be loaded from a prestored firmware database (DB), and may be downloaded from an official website.

On the corresponding board, the firmware is typically stored in separate flash memory, so that, at step S310, the firmware may be extracted without separate modification of the board or may be extracted by removing a memory chip from the board, i.e., through a chip-off method, depending on the states of the board and the memory.

Here, in the procedure at step S310, whether the memory interface of the verification target board is available may be checked at step S420.

That is, at step S420, whether the verification target board is in the state in which a memory chip is readable/writable through a serial port or a device such as a Joint Test Action Group (JTAG) device may be checked.

Here, in a procedure at step S420, if the verification target board is not in the state in which a memory chip is readable/writable, firmware may be extracted by reading the memory chip at step S430, whereas if the verification target board is in the state in which the memory chip is readable/writable, firmware may be extracted using the memory interface at step S440.

In this case, at step S450, the state of the pin of the memory chip may be checked, and in particular, whether the memory pin is exposed outside (i.e., in an OUT state) may be checked.

Here, if it is determined at step S450 that the memory pin is not exposed outside, the memory chip is removed from the board (i.e., chip-off), and a memory reader may directly access the memory chip removed from the board to extract the firmware therefrom at step S460. In contrast, if the verification target board is in the state in which the memory interface is unavailable and the memory pin is exposed outside, firmware may be extracted using a micro-probe at step S470.

Here, at step S460, after the memory chip is removed from the board, it is mounted on the memory reader to extract the firmware. After the firmware is extracted, the memory chip may be mounted on the board again by being soldered onto the board, or using a chip socket or the like.

Also, in the procedure at step S120, a hash operation and an unpack operation may be performed at step S320.

That is, at step S320, data may be extracted through a hash operation and an unpack operation by the first firmware and the second firmware.

That is, at step S320, a bootloader, a kernel, and an operating system (OS) may be separated as respective pieces of data from the corresponding firmware through the unpack operation, and compressed data may be decompressed.

At step S320, the extracted firmware performs a hash operation and an unpack operation using the same method as for the firmware of the source board (source firmware).

Further, in the procedure at step S120, version information may be extracted at step S330.

Here, at step S330, version information may be acquired from the extracted data.

Further, in the procedure at step S120, a source board firmware database (DB) may be constructed at step S340.

That is, at step S340, the source board firmware DB may be constructed in advance from downloaded source firmware data, and may then be used for a comparison.

Furthermore, in the procedure at step S120, the pieces of data extracted from the firmware of the verification target board and the firmware of the source board may be compared with each other at step S350.

That is, at step S350, firmware hash values extracted from the firmware of the verification target board and the firmware of the source board may be compared with each other, as to whether the firmware hash values are identical to each other.

Further, in the procedure at step S120, whether the firmware hash values are identical to each other may be determined at step S360.

That is, if it is determined at step S360 that the firmware hash values are not identical to each other, pieces of detailed data that are extracted may be compared with each other, and an area suspected to have been modified and a related task may be reported at step S370, whereas if it is determined at step S360 that the firmware hash values are identical to each other, the results of the determination may be reported at step S380.

That is, at step S370, if the firmware hash values are not identical to each other, malicious modification may be determined to be present, the pieces of detailed data may again be compared with each other, and the area suspected to have been modified and a related task may be reported.

Next, the method for verifying the integrity of a hardware board according to the embodiment of the present invention may perform a board integrity check at step S130.

That is, at step S130, the integrity of the verification target board may be verified based on whether the images are identical to each other and on whether the pieces of firmware are identical to each other.

Here, at step S130, if it is determined both that the images are identical to each other and that the pieces of firmware are identical to each other, it may be determined that no fault is present in the integrity of the verification target board.

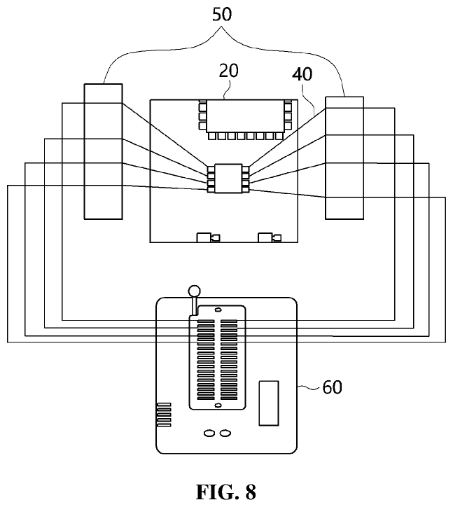

FIG. 8 is a diagram illustrating a process of extracting firmware from a verification target board according to an embodiment of the present invention.

Referring to FIG. 8, it can be seen that the process of extracting firmware from the verification target board 20 using a micro-probe and a memory reader is illustrated.

The micro-probe may be a fine probe, which may be used to be connected to individual pins of a memory chip, and may be stably connected to respective pins 40 through fixing devices 50.

The micro-probe connected to the respective pins 40 may be connected to the input pins of a memory reader 60, through which firmware may be extracted.

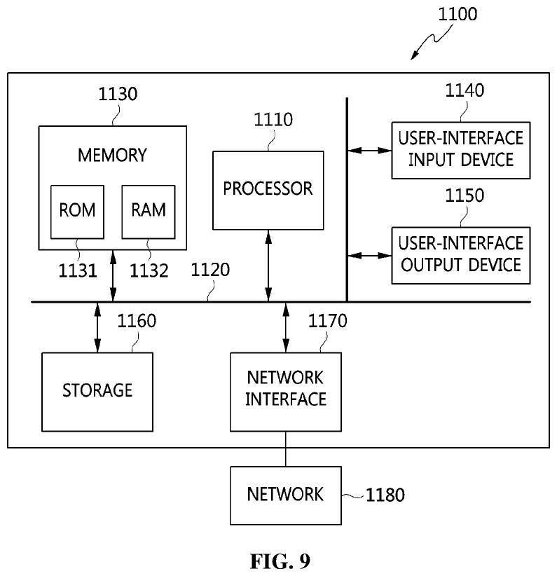

FIG. 9 is a diagram illustrating a computer system according to an embodiment of the present invention.

Referring to FIG. 9, an apparatus for verifying the integrity of a hardware board according to an embodiment of the present invention may be implemented in a computer system 1100, such as a computer-readable storage medium. As illustrated in FIG. 9, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for verifying the integrity of a hardware board according to an embodiment of the present invention may include one or more processors 1110 and execution memory 1130 for storing at least one program that is executed by the one or more processors, wherein the at least one program is configured to compare images of components arranged on a verification target board and a source board with each other in a first image, obtained by photographing the verification target board, and in a second image prestored for the source board, as to whether the images of the components are identical to each other, and compare first firmware extracted from the verification target board with second firmware of the source board, as to whether the first firmware is identical to the second firmware and verify the integrity of the verification target board based on whether the images are identical to each other and on whether the pieces of firmware are identical to each other.

Here, the at least one program may be configured to normalize the first image and the second image into an identical shape with respect to board sizes and board directions of the first and second images.

Here, the at least one program may be configured to compare pieces of data that are extracted through a hash operation and an unpack operation by the first firmware and the second firmware.

Here, the unpack operation may be configured to separate a bootloader, a kernel, and an operating system, as respective pieces of data, from corresponding firmware and to decompress compressed data.

The at least one program may be configured to extract the first firmware using a micro-probe and a memory reader when the verification target board is in the state in which a memory interface is unavailable and a memory pin is exposed outside.

The at least one program may be configured to extract the first firmware by causing a memory reader to directly access a memory chip removed from the verification target board when the verification target board is in a state in which a memory interface is unavailable in and a memory pin is not exposed outside.

The present invention may verify the integrity of a hardware board of a supply chain.

Further, the present invention may detect malicious modification when a board is modified with malicious intent.

Furthermore, the present invention may verify integrity in a board environment in which it is difficult to extract firmware.

As described above, in the apparatus and method for verifying the integrity of a hardware board according to the present invention, the configurations and schemes in the above-described embodiments are not limitedly applied, and some or all of the above embodiments can be selectively combined and configured so that various modifications are possible.

What is claimed is:

1. An apparatus for verifying integrity of a hardware board, comprising:
one or more processors; and
an execution memory for storing at least one program that is executed by the one or more processors,
wherein the at least one program is configured to:
compare images of components arranged on a verification target board and a source board with each other in a first image, obtained by photographing the verification target board, and in a second image prestored for the source board, as to whether the images of the components are identical to each other, and
compare first firmware extracted from the verification target board with second firmware of the source board, as to whether the first firmware is identical to the second firmware and verify the integrity of the verification target board based on whether the images are identical to each other and on whether the pieces of firmware are identical to each other.

2. The apparatus of claim 1, wherein the at least one program is configured to normalize the first image and the second image into an identical shape with respect to board sizes and board directions of the first and second images.

3. The apparatus of claim 2, wherein the at least one program is configured to compare pieces of data that are extracted through a hash operation and an unpack operation by the first firmware and the second firmware.

4. The apparatus of claim 3, wherein the unpack operation is configured to separate a bootloader, a kernel, and an operating system, as respective pieces of data, from corresponding firmware and to decompress compressed data.

5. The apparatus of claim 3, wherein the at least one program is configured to extract the first firmware using a micro-probe and a memory reader when the verification target board is in a state in which a memory interface is unavailable and a memory pin is exposed outside.

6. The apparatus of claim 3, wherein the at least one program is configured to extract the first firmware by causing a memory reader to directly access a memory chip removed from the verification target board when the verification target board is in a state in which a memory interface is unavailable in and a memory pin is not exposed outside.

7. A method for verifying integrity of a hardware board, the method being performed by an apparatus for verifying the integrity of the hardware board, the method comprising:
comparing images of components arranged on a verification target board and a source board with each other in a first image, obtained by photographing the verification target board, and in a second image prestored for the source board, as to whether the images of the components are identical to each other;
comparing first firmware extracted from the verification target board with second firmware of the source board, as to whether the first firmware is identical to the second firmware; and
verifying the integrity of the verification target board based on whether the images are identical to each other and on whether the pieces of firmware are identical to each other.

8. The method of claim 7, wherein comparing the images of the components comprises:
normalizing the first image and the second image into an identical shape with respect to board sizes and board directions of the first and second images.

9. The method of claim 8, wherein comparing the first firmware extracted from the verification target board with the second firmware of the source board comprises:
comparing pieces of data that are extracted through a hash operation and an unpack operation by the first firmware and the second firmware.

10. The method of claim 9, wherein the unpack operation is configured to separate a bootloader, a kernel, and an operating system, as respective pieces of data, from corresponding firmware and to decompress compressed data.

11. The method of claim 9, wherein comparing the first firmware extracted from the verification target board with the second firmware of the source board further comprises:
extracting the first firmware using a micro-probe and a memory reader when the verification target board is in a state in which a memory interface is unavailable and a memory pin is exposed outside.

12. The method of claim 9, wherein comparing the first firmware extracted from the verification target board with the second firmware of the source board further comprises:
extracting the first firmware by causing a memory reader to directly access a memory chip removed from the verification target board when the verification target board is in a state in which a memory interface is unavailable in and a memory pin is not exposed outside.
